(19) United States
(12) Patent Application Publication
(10) Pub. No.: US 2013/0203353 A1
(43) Pub. Date: Aug. 8, 2013

(54) SHORT-RANGE RADIO COMMUNICATION SYSTEM AND METHOD FOR OPERATING THE SAME

(71) Applicant: Samsung Electronics Co., Ltd., Suwon-si (KR)

(72) Inventors: Jung-Tae KIM, Yongin-si (KR); Ho-Sung YOU, Gunpo-si (KR)

(73) Assignee: SAMSUNG ELECTRONICS CO. LTD., Suwon-si (KR)

(21) Appl. No.: 13/727,321

(22) Filed: Dec. 26, 2012

(30) Foreign Application Priority Data
Feb. 2, 2012 (KR) 10-2012-0010715

(51) Int. Cl. H04M 1/02; H04B 7/24

(52) U.S. Cl. CPC H04M 1/0285; H04B 7/24
USPC 455/41.2; 455/556.1

(57) ABSTRACT

A Short-range Radio Communication (SRC) system and method are provided. The system includes a first terminal and a second terminal capable of connecting to each other by one or more SRCs. When having share information and being connected to the second terminal by the one or more SRCs, the first terminal transmits the share information to the second terminal. When being SRC-connected to the first terminal the one or more SRCs, the second terminal receives the share information from the first terminal

### PRIORITY

This application claims the benefit under 35 U.S.C. §119(a) of a Korean patent application filed on Feb. 2, 2012 in the Korean Intellectual Property Office and assigned Serial No. 10-2012-0010715, the entire disclosure of which is hereby incorporated by reference.

### BACKGROUND OF THE INVENTION

1. Field of the Invention

The present invention relates to a Short-range Radio Communication (SRC) system. More particularly, the present invention relates to a system for sharing information between two devices by near field communication and a method for operating the same.

2. Description of the Related Art

Short-range Radio Communication (SRC) enables data exchange between devices within a short distance. Since SRC enables interactive communication through read and write operations, it is applied to various service fields such as electronic payment, ticketing, door lock, and product certification. Recently, as the utilization of SRC increases, the tendency of applying SRC to portable terminals increases.

In addition, as extensive multimedia are provided, the capabilities of portable terminals increases, and a User Interface (UI) providing a smooth interaction between a user and a portable terminal becomes more important.

Generally, in the past, SRC has been used merely to exchange simple data. There is therefore a need for a system providing a user interface capable of satisfying users and a method for operating the same.

### SUMMARY OF THE INVENTION

Aspects of the present invention are to address at least the above-mentioned problems and/or disadvantages and to provide at least the advantages described below. Accordingly, an aspect of the present invention is to provide a system for improving a User eXperience (UX) in exchanging information by Short-range Radio Communication (SRC), and a method for operating the same.

Another aspect of the present invention is to provide a stylus pen having an SRC function.

Another aspect of the present invention is to provide an SRC system for performing information exchange between a first terminal and a second terminal through a stylus pen having an SRC function, and a method for operating the same.

Another aspect of the present invention is to provide an SRC system for transmitting share information of a first terminal to a second terminal when the first terminal and the second terminal are SRC-connected, and a method for operating the same.

In accordance with an aspect of the present invention, an SRC system is provided. The system includes a first terminal and a second terminal capable of connecting to each other by one or more SRCs, wherein when having share information and being connected to the second terminal by the one or more SRCs, the first terminal transmits the share information to the second terminal, and when being SRC-connected to the first terminal by the one or more SRCs, the second terminal receives the share information from the first terminal.

In accordance with another aspect of the present invention, a stylus pen for a touchscreen is provided. The stylus pen includes a storage unit for storing a program for controlling operation of the stylus pen, and various data that are at least one of input and output when a control operation is performed, and a control unit for controlling operation of the stylus pen and at least one of modulating and demodulating of data.

In accordance with another aspect of the present invention, a method for operating an SRC system is provided. The method includes a first terminal and a second terminal capable connecting to each other by one or more SRCs is provided. The method includes transmitting, by the first terminal, share information to the second terminal when the first terminal and the second terminal are connected by the one or more SRCs, and receiving, by the second terminal, the share information from the first terminal when the first terminal and the second terminal are connected by one or more SRCs.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1A is a diagram illustrating a configuration of a Short-range Radio Communication (SRC) system according to an exemplary embodiment of the present invention;

FIG. 1B is a diagram illustrating a configuration of an SRC system according to an exemplary embodiment of the present invention;

FIG. 2 is a block diagram of a portable terminal according to an exemplary embodiment of the present invention;

FIG. 3 is a communication flow diagram of an SRC system according to an exemplary embodiment of the present invention;

FIG. 4A is a diagram illustrating a configuration of an SRC system according to an exemplary embodiment of the present invention;

FIG. 4B is a diagram illustrating a stylus pen according to an exemplary embodiment of the present invention;

FIG. 4C is a block diagram of a stylus pen according to an exemplary embodiment of the present invention;

FIG. 5 is a communication flow diagram of an SRC system according to an exemplary embodiment of the present invention;

FIG. 6 is a communication flow diagram of an SRC system according to an exemplary embodiment of the present invention;

FIG. 7 is a diagram illustrating a User Interface (UI) screen according to an exemplary embodiment of the present invention;

FIG. 8 is a diagram illustrating a UI screen according to an exemplary embodiment of the present invention;

FIG. 9 is a diagram illustrating a UI screen according to an exemplary embodiment of the present invention;

FIG. 10 is a diagram illustrating a UI screen according to an exemplary embodiment of the present invention;

FIG. 11 is a diagram illustrating a UI screen according to an exemplary embodiment of the present invention;

FIG. 12 is a diagram illustrating a UI screen according to an exemplary embodiment of the present invention;

FIG. 13 is a diagram illustrating a UI screen according to an exemplary embodiment of the present invention; and

FIG. 14 is a diagram illustrating a UI screen according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a system for improving a User eXperience (UX) in exchanging information by Short-range Radio Communication (SRC), and a method for operating the same. In an exemplary embodiment of the present invention, when a first terminal and a second terminal are SRC-connected, share information of the first terminal is transmitted to the second terminal When the first terminal uses a touchscreen, a user may determine share information by touch. In an exemplary embodiment of the present invention, information exchange between the first terminal and the second terminal may be performed through a stylus pen. The SRC function of the stylus pen may be implemented as a near-field communication (NFC) function. In addition, the stylus pen includes a unit for storing information and a unit for controlling information reception/transmission from/to a counterpart terminal. The exemplary embodiments of present invention may provide an improved UX when exchanging information between devices by SRC.

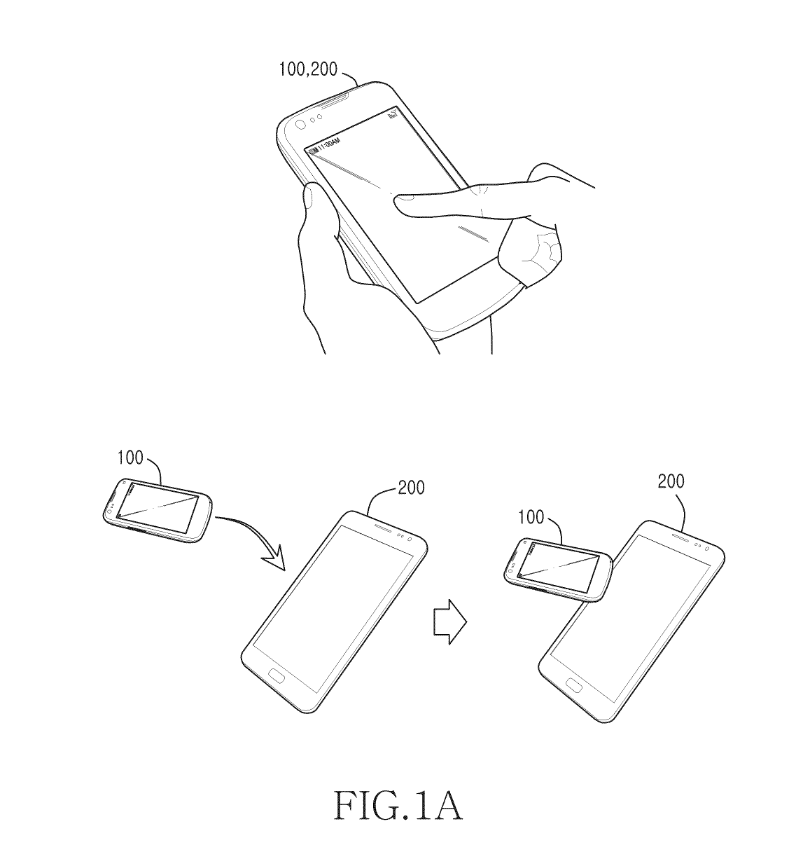

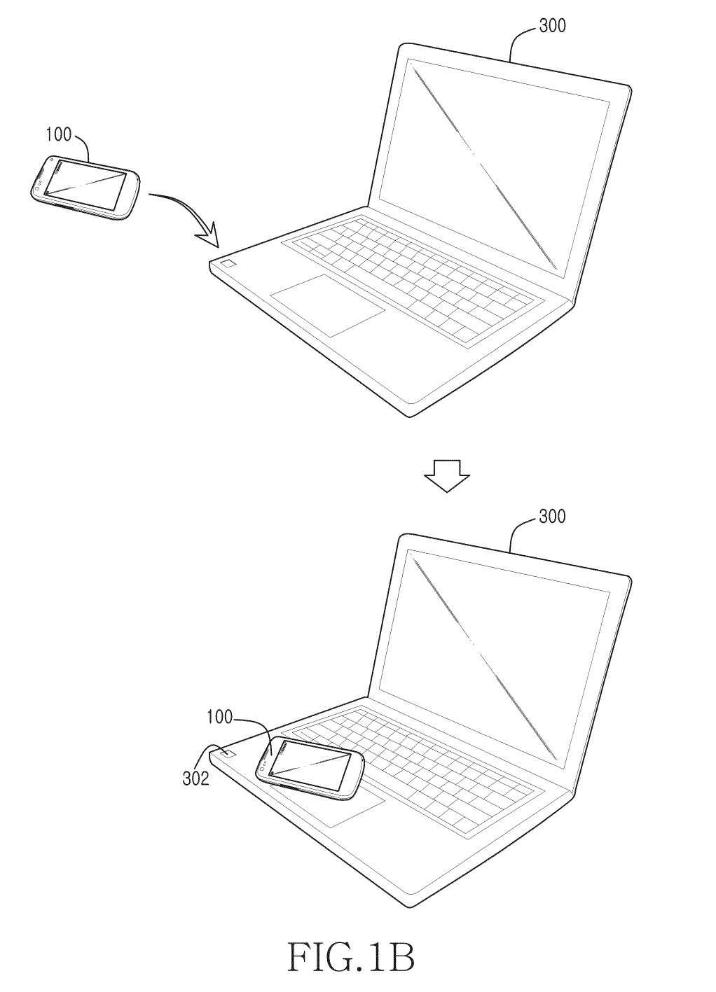

FIG. 1A illustrates a configuration of an SRC system according to an exemplary embodiment of the present invention. FIG. 1B illustrates a configuration of an SRC system according to an exemplary embodiment of the present invention.

Referring to FIGS. 1A and 1B, the SRC system may include a first terminal 100 and a second terminal 200/300 that are capable of SRC. When the first terminal 100 and the second terminal 200/300 approach and recognize each other and are SRC-connected, predetermined information of the first terminal 100 may be transmitted to the second terminal 200/300. In one exemplary embodiment, when the second terminal 300 is larger than the first terminal 100, the first terminal 100 may approach a particular portion 302 of the second terminal 300. The particular portion 302 may be visually distinguished so as to be recognizable to a user. When the first terminal 100 uses a touchscreen, a user may determine share information such as a picture, a moving image, a Uniform Resource Locator (URL), and a contact number by touch. When the first terminal 100 and the second terminal 200/300 are SRC-connected, share information of the first terminal 100 may be transmitted to the second terminal 200/300 automatically or according to user determination. The second terminal 200/300 may execute a program or process for processing information received from the first terminal 100. For example, the second terminal 200/300 may execute an image viewer to read a received picture file.

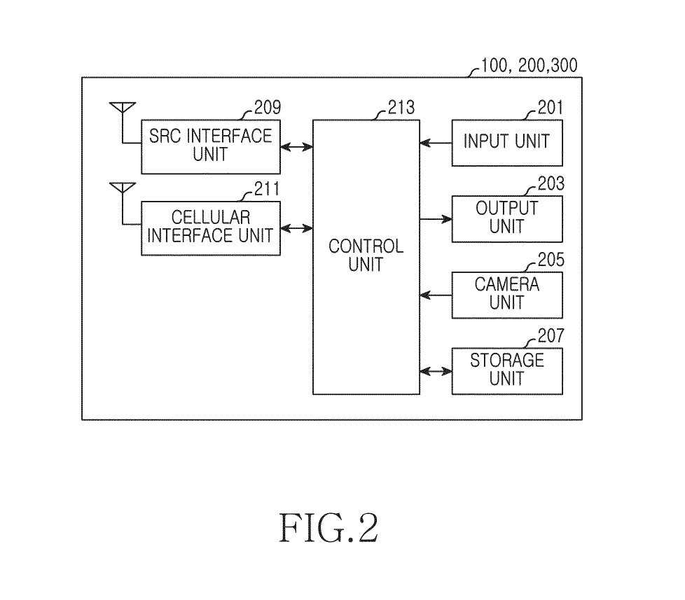

FIG. 2 is a block diagram of a terminal according to an exemplary embodiment of the present invention.

Referring to FIG. 2, the terminal 100/200/300 may include an input unit 201, an output unit 203, a camera unit 205, a storage unit 207, an SRC interface unit 209, a cellular interface unit 211, and a control unit 213. In the following description, examples of the terminal 100/200/300 include a portable terminal, a mobile phone, a mobile pad, a media player, a tablet computer, a handheld computer, and a Personal Digital Assistant (PDA). The following description will be made based on a general configuration of the above examples.

The input unit 201 may include a plurality of buttons, and output input data corresponding to the button pressed by a user, to the control unit 213. In addition, the input unit 201 may include a microphone, and output voice data corresponding to user voice, to the control unit 213. The control unit 213 may modulate the voice data received from the microphone.

The output unit 203 may include a display and a speaker, and output images or voices under the control of the control unit 213. The control unit 213 may demodulate image data and output the result to the output unit 203, and may demodulate voice data and output the result to the output unit 203.

The camera unit 205 may capture an image of an object to generate image data, and output the image data to the control unit 213. The control unit 213 may modulate the image data received from the camera unit 205.

The storage unit 207 may store a program for controlling an overall operation of the terminal 100/200/300, and various data that are input/output when a control operation of the terminal 100/200/300 is performed.

The SRC interface unit 209 may have at least one of mechanical, electrical and software configurations for SRC such as NFC, Bluetooth, and WiFi Direct, and exchange data with a counterpart terminal.

The cellular interface unit 211 may have mechanical, electrical and software configurations for cellular communication. The cellular interface unit 211 may down-convert a Radio Frequency (RF) signal received through an antenna and provide the result to the control unit 213, and may up-convert a baseband signal from the control unit 213 and transmit the result through the antenna.

The control unit 213 may control an overall operation of the terminal 100/200/300, and may process and control operations of the present invention.

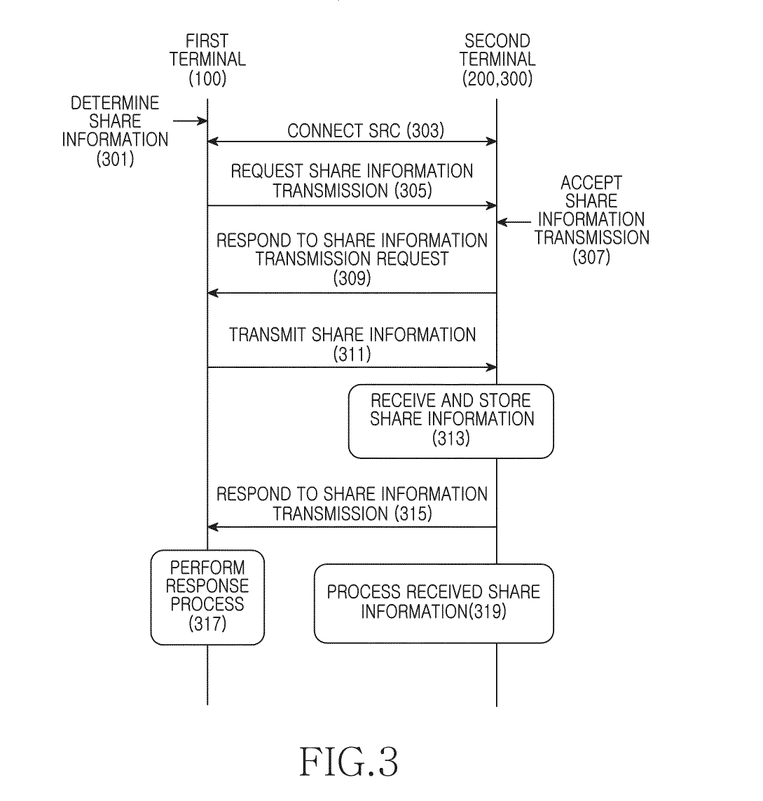

FIG. 3 is a communication flow diagram of an SRC system according to an exemplary embodiment of the present invention.

Referring to FIG. 3, a user determines share information in the first terminal 100 in step 301. When the first terminal 100 and the second terminal 200/300 approach each other and are SRC-connected in step 303, the first terminal 100 requests transmission of the determined share information to the second terminal 200/300 in step 305. The user accepts transmission of the share information to the second terminal 200/300 in step 307, and the second terminal 200/300 responds to the first terminal 100 in step 309. The first terminal 100 transmits the share information to the second terminal 200/300 in step 311, and the second terminal 200/300 receives and stores the share information from the first terminal 100 in step 313. When completing reception of the share information, the second terminal 200/300 notifies this to the first terminal 100 in step 315. The first terminal 100 performs a process corresponding to the response in step 317. For example, the first terminal 100 releases the share setting of the share information. The second terminal 200/300 executes a program or process for processing the received share information in step 319. For example, the second terminal 200/300 executes an image viewer to read a received picture file.

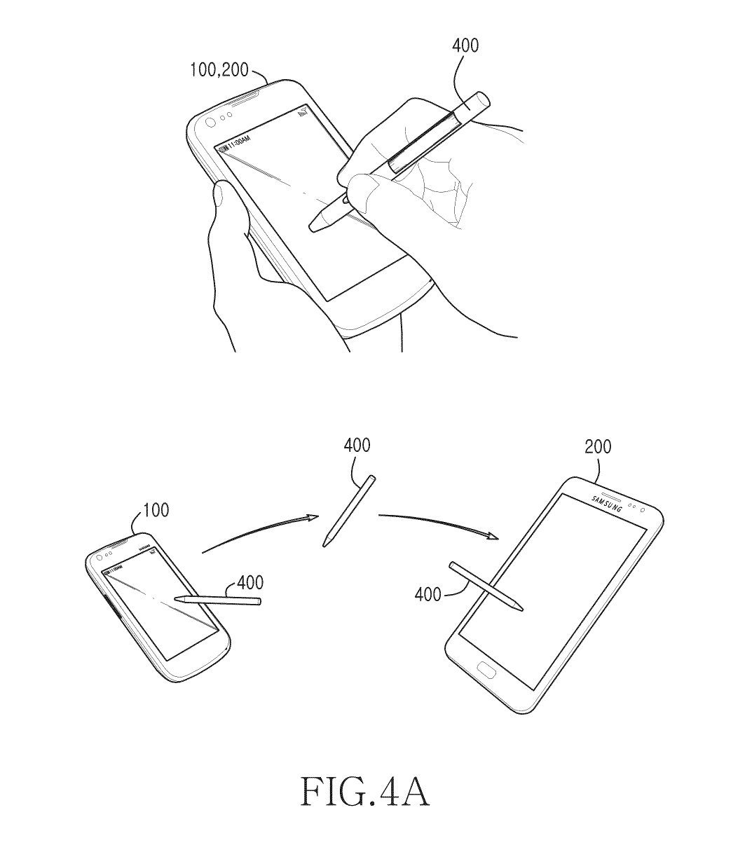

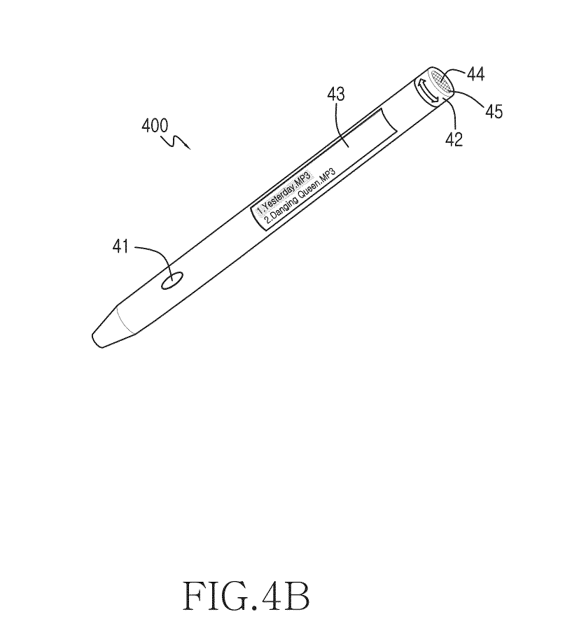

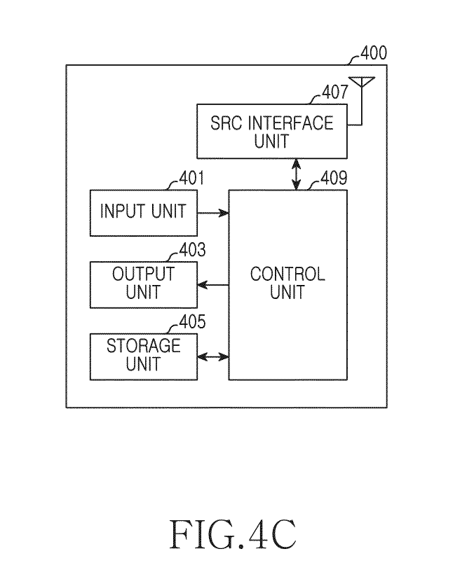

FIG. 4A is a diagram illustrating a configuration of an SRC system according to an exemplary embodiment of the present invention.

Referring to FIG. 4A, the SRC system may include a first terminal 100, a second terminal 200, and a stylus pen 400. The first terminal 100, the second terminal 200, and the stylus pen 400 have an SRC function. The stylus pen 400 is used to designate a position on a touchscreen.

The user determines share information on the touchscreen of the first terminal 100 by using the stylus pen 400. The first terminal 100 transmits the determined share information to the stylus pen 400, and the stylus pen 400 receives and stores the share information from the first terminal 100.

The stylus pen 400 and the second terminal 200 approach and recognize each other and are SRC-connected, and the stylus pen 400 transmits the stored share information to the second terminal 200 automatically or according to a user determination. The second terminal 200 executes a program or process for processing the share information received from the stylus pen 400.

FIG. 4B is a diagram illustrating a stylus pen according to an exemplary embodiment of the present invention.

Referring to FIG. 4B, the stylus pen 400 may have a general pen shape, and may include input units 41 and 42, a display 43, a speaker 44, a microphone 45, a memory, a power supply unit, and a control unit. In addition, the stylus pen 400 may store share information to be transmitted to a counterpart terminal, in the memory, display the details of the stored share information on the display 43 to the user, and receive a control signal, such as selection and transmission of the share information, from the user through the input units 41 and 42. Also, the stylus pen 400 may reproduce an audio file stored in the memory, through the speaker 44. In addition, the stylus pen 400 may SRC-communicate with a terminal, demodulate audio data or image data received from the terminal, and output the results the display 43 and the speaker 44. In addition, the stylus pen 400 may SRC-communicate with a terminal, and transmit audio data input through the microphone 45, to the terminal. According to this configuration, the stylus pen 400 may be used for a Bluetooth call of a terminal. The control unit may control an overall operation of the stylus pen 400, and may process and control operations of the present invention.

FIG. 4C is a block diagram of a stylus pen according to an exemplary embodiment of the present invention.

Referring to FIG. 4C, the stylus pen 400 may include an input unit 401, an output unit 403, a storage unit 405, an SRC interface unit 407, and a control unit 409.

The input unit 401 may include a plurality of buttons, and output input data corresponding to the button pressed by a user, to the control unit 409. In addition, the input unit 401 may include a microphone, and output voice data corresponding to user voice, to the control unit 409. The control unit 409 may modulate the voice data received from the microphone.

The output unit 403 may include a display and a speaker, and output images or voices under the control of the control unit 409. The control unit 409 may demodulate image data and output the result to the output unit 403, and may demodulate voice data and output the result to the output unit 403.

The storage unit 405 may store a program for controlling an overall operation of the stylus pen 400, and various data that are input/output when a control operation of the stylus pen 400 is performed.

The SRC interface unit 407 may have mechanical, electrical and software configurations for SRC such as NFC, Bluetooth, and WiFi Direct, and exchange data with a counterpart terminal.

The control unit 409 may control an overall operation of the stylus pen 400, and may process and control operations of the present invention.

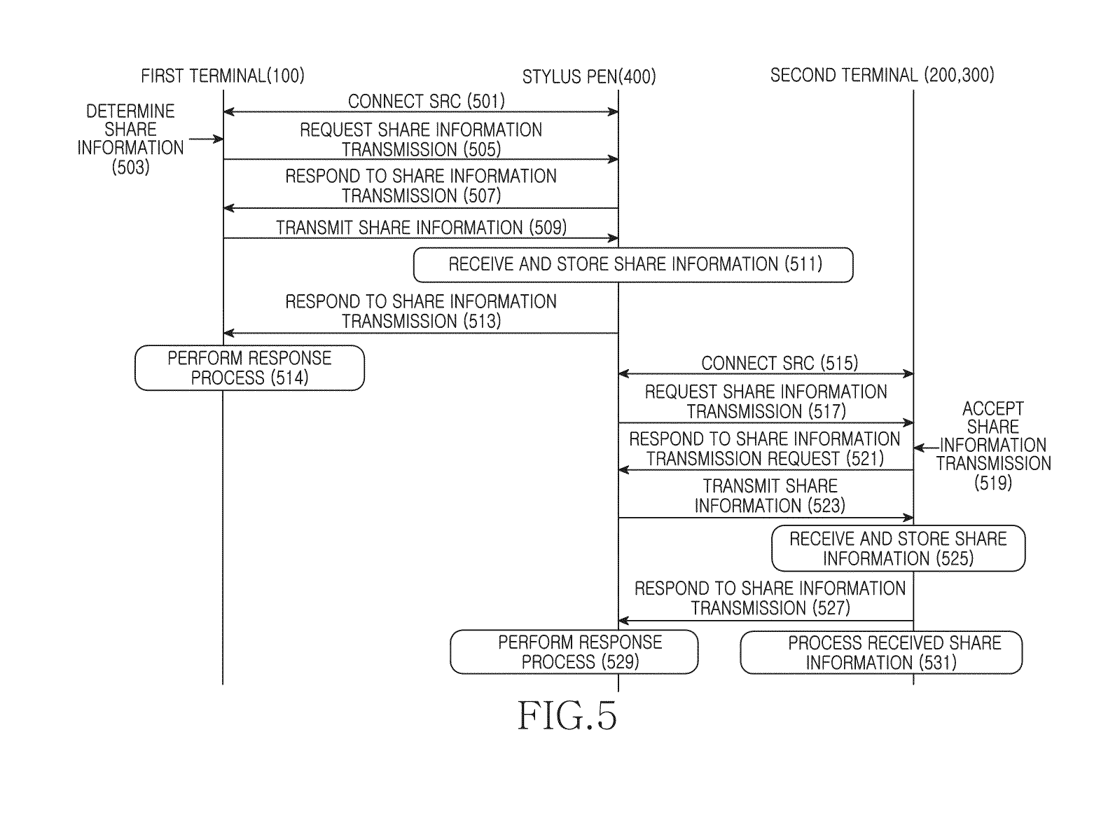

FIG. 5 is a communication flow diagram of an SRC system according to an exemplary embodiment of the present invention.

Referring to FIG. 4, a first terminal 100 and a stylus pen 400 are SRC-connected in step 501, and a user determines share information on a touchscreen of the first terminal 100 by using the stylus pen 400 in step 503. The first terminal 100 requests transmission of the determined share information to the stylus pen 400 in step 505. The stylus pen 400 responds to the share information transmission in step 507, and the first terminal 100 transmits the share information to the stylus pen 400 in step 509. The stylus pen 400 receives and stores the share information from the first terminal 100 in step 511, and notifies of the completion of reception of the share information to the first terminal 100 in step 513. The first terminal 100 performs a process corresponding to the notification in step 514. For example, the first terminal 100 releases the determination of the share information.

The stylus pen 400 and a second terminal 200/300 are SRC-connected in step 515, and the stylus pen 400 requests transmission of the determined share information to the second terminal 200/300 in step 517. The user accepts transmission of the share information to the second terminal 200/300 in step 519, and the second terminal 200/300 responds to the share information transmission request in step 521. The stylus pen 400 transmits the share information to the second terminal 200/300 in step 523. The second terminal 200/300 receives and stores the share information from the stylus pen 400 in step 525, and notifies of the completion of reception of the share information to the stylus pen 400 in step 527. The stylus pen 400 performs a process corresponding to the notification in step 529. For example, the stylus pen 400 may delete the share information. The second terminal 200/300 executes a program or process for processing the received share information in step 531, an example of which will be described below with reference to the drawings.

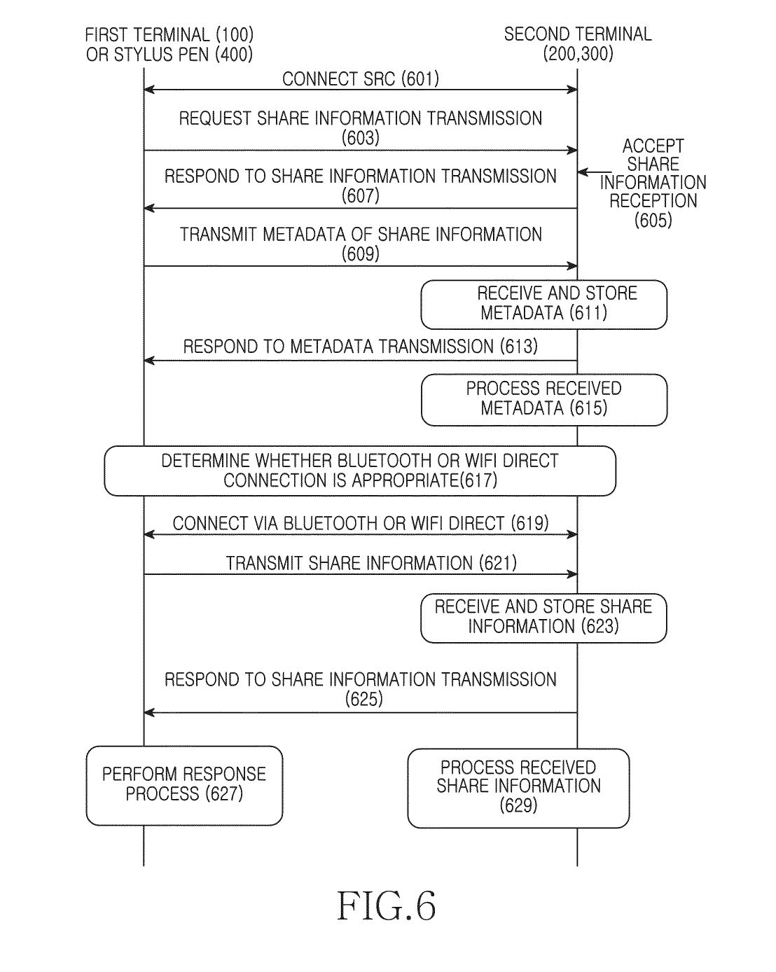

FIG. 6 is a communication flow diagram of an SRC system according to an exemplary embodiment of the present invention.

Referring to FIG. 6, a first terminal 100 or a stylus pen 400 is NFC-connected to a second terminal 200/300 in step 601, and the first terminal 100 or the stylus pen 400 requests transmission of share information to the second terminal 200/300 in step 603. A user accepts transmission of the share information in step 605, and the second terminal 200/300 responds to the share information transmission request in step 607. The first terminal 100 or the stylus pen 400 transmits metadata of the share information to the second terminal 200/300 in step 609. The second terminal 200/300 receives and stores the metadata from the first terminal 100 or the stylus pen 400 in step 611, and notifies of the completion of reception of the metadata to the terminal 100 or the stylus pen 400 in step 613. The second terminal 200/300 executes a program or process for processing the received metadata in step 615. For example, the second terminal 200/300 provides the user with content, format, right condition, and creator information of the share information. At least one of the first terminal 100, the stylus pen 400 and the second terminal 200/300 determines from the metadata whether a Bluetooth or WiFi Direct connection is necessary. When the amount of share information is considerable, it may be difficult to transmit the share data through the NFC connection. Therefore, using Bluetooth or WiFi Direct, which provides a higher data rate than NFC, may be more appropriate. When the Bluetooth or WiFi Direct connection is not necessary, the NFC connection is used to follow the process described above with reference to FIGS. 3 and 5. When the Bluetooth or WiFi Direct connection is more appropriate in step 617, the first terminal 100 or the stylus pen 400 and the second terminal 200/300 are Bluetooth or WiFi Direct-connected through authentication in step 619. The first terminal 100 or the stylus pen 400 transmits the share information to the second terminal 200/300 in step 621. The second terminal 200/300 receives and stores the share information from the first terminal 100 or the stylus pen 400 in step 623, and notifies of the completion of reception of the share information to the terminal 100 or the stylus pen 400 in step 625. The first terminal 100 or the stylus pen 400 performs a process corresponding to the notification in step 627. For example, the first terminal 100 or the stylus pen 400 deletes the share information. The second terminal 200/300 executes a program or process for processing the received share information in step 629, an example of which will be described below with reference to the drawings.

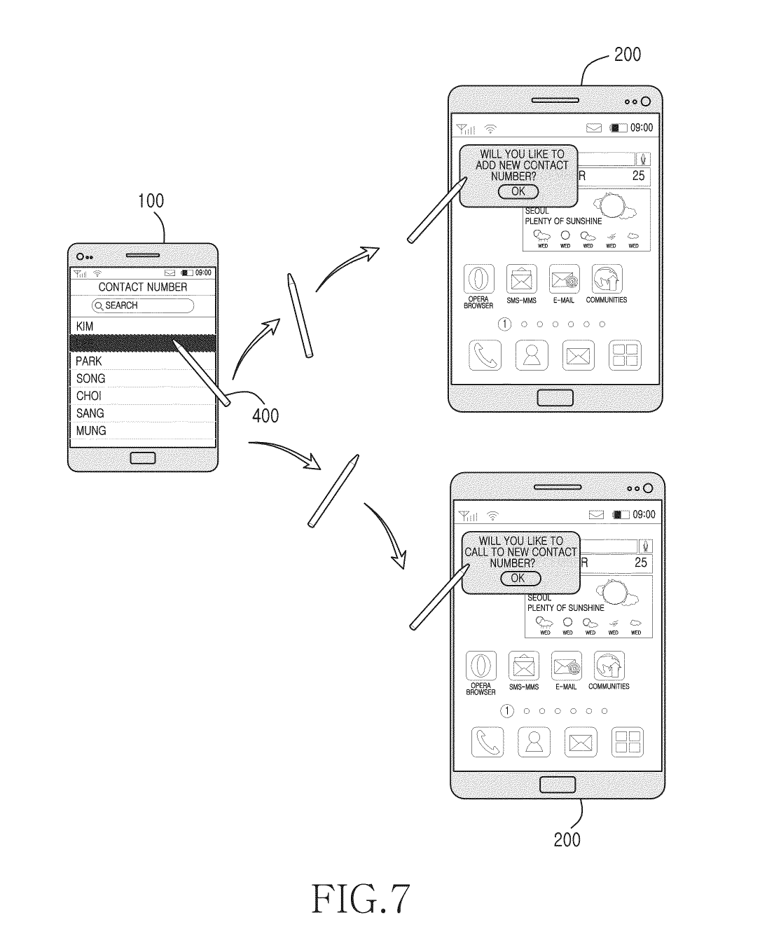

FIG. 7 illustrates a User Interface (UI) screen according to an exemplary embodiment of the present invention.

Referring to FIG. 7, a user touches at least one contact number in a contact number list on a touchscreen of a first terminal 100 by using a stylus pen 400. The first terminal 100 transmits contact number information touched with the stylus pen 400 to the stylus pen 400 by using at least one of NFC, Bluetooth and WiFi Direct, and the stylus pen 400 receives and stores the contact number information from the first terminal 100. When the user touches a touchscreen of a second terminal 200 by using the stylus pen 400, the stylus pen 400 transmits the stored contact number information received from the first terminal 100, to the second terminal 200 by using at least one of NFC, Bluetooth and WiFi Direct. The second terminal 200 receives the contact number information from the stylus pen 400, and executes a program or process for processing the received contact number information. For example, the second terminal 200 performs contact number registration, a call, or the like.

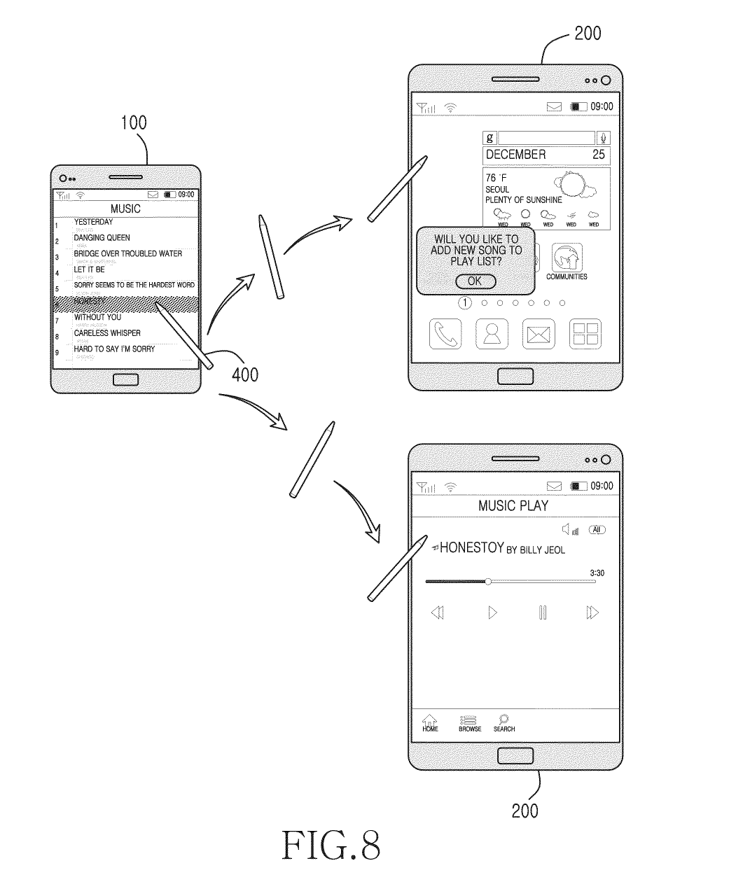

FIG. 8 illustrates a UI screen according to an exemplary embodiment of the present invention.

Referring to FIG. 8, a user touches at least one music file in a music list on a touchscreen of a first terminal 100 by using a stylus pen 400. The first terminal 100 transmits the touched music file to the stylus pen 400 by using at least one of NFC, Bluetooth and WiFi Direct, and the stylus pen 400 receives and stores the music file from the first terminal 100. When the user touches a touchscreen of a second terminal 200 by using the stylus pen 400, the stylus pen 400 transmits the stored music file received from the first terminal 100, to the second terminal 200 by using at least one of NFC, Bluetooth and WiFi Direct. The second terminal 200 receives the music file from the stylus pen 400, and executes a program or process for processing the received music file. For example, the second terminal 200 performs addition to a play list, reproduction through a music play program, or the like.

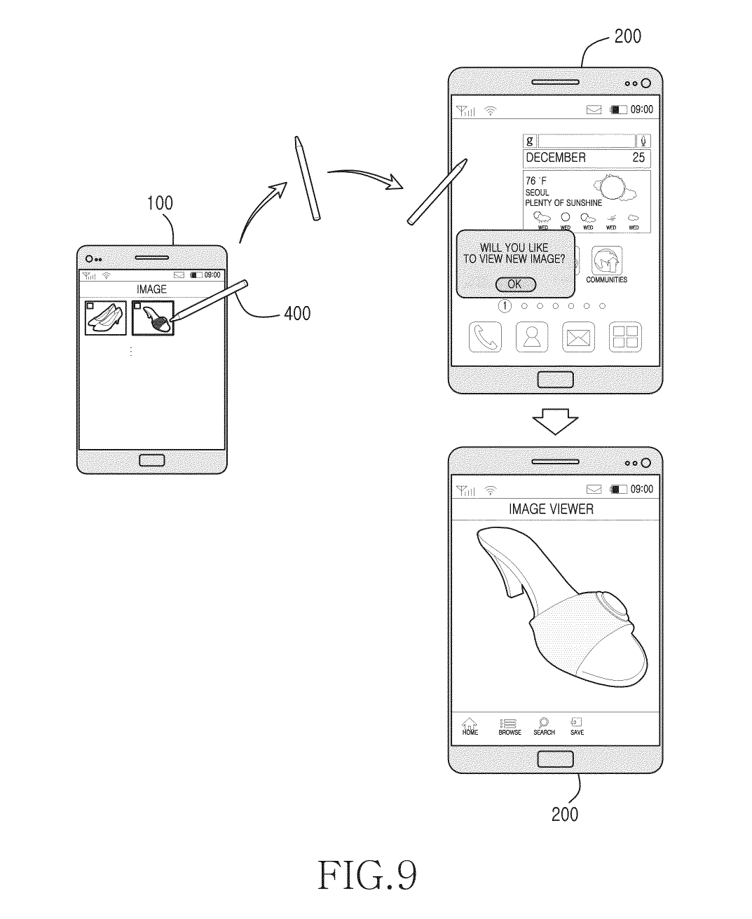

FIG. 9 illustrates a UI screen according to an exemplary embodiment of the present invention.

Referring to FIG. 9, a user touches at least one picture file in an image thumbnail on a touchscreen of a first terminal 100 by using a stylus pen 400. The first terminal 100 transmits the touched picture file to the stylus pen 400 by using at least one of NFC, Bluetooth and WiFi Direct, and the stylus pen 400 receives and stores the picture file from the first terminal 100. When the user touches a touchscreen of a second terminal 200 by using the stylus pen 400, the stylus pen 400 transmits the stored picture file received from the first terminal 100, to the second terminal 200 by using at least one of NFC, Bluetooth and WiFi Direct. The second terminal 200 receives the picture file from the stylus pen 400, and executes a program or process for processing the received picture file. For example, the second terminal 200 opens the received picture file through an image viewer.

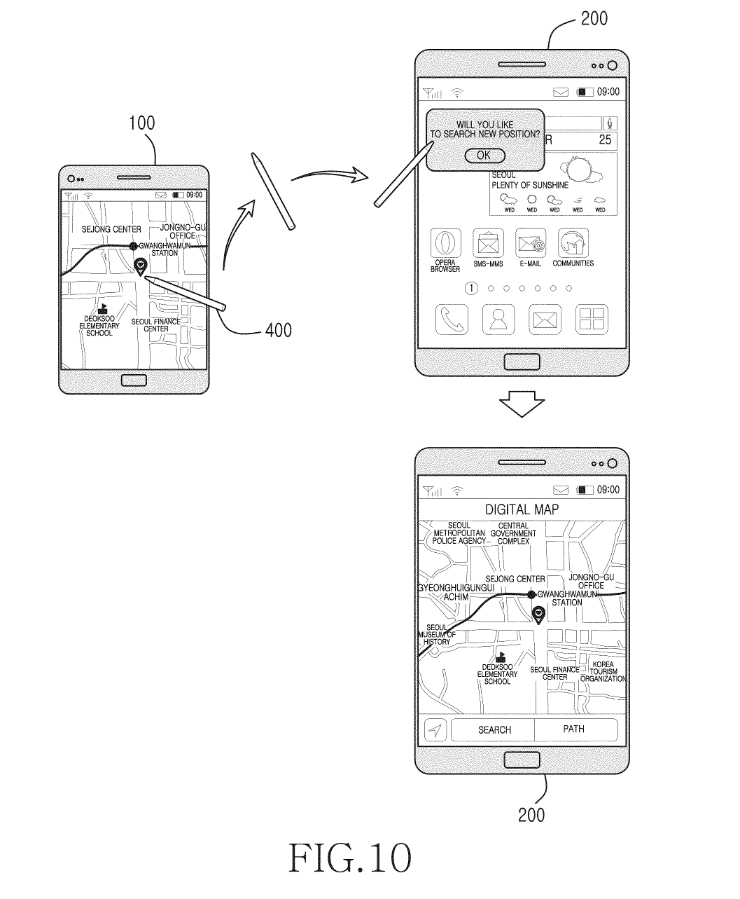

FIG. 10 illustrates a UI screen according to an exemplary embodiment of the present invention.

Referring to FIG. 10, a user designates a position in an electronic map on a touchscreen of a first terminal 100 by using a stylus pen 400. The first terminal 100 transmits the designated position information to the stylus pen 400 by using at least one of NFC, Bluetooth and WiFi Direct, and the stylus pen 400 receives and stores the position information from the first terminal 100. When the user touches a touchscreen of a second terminal 200 by using the stylus pen 400, the stylus pen 400 transmits the stored position information received from the first terminal 100, to the second terminal 200 by using at least one of NFC, Bluetooth and WiFi Direct. The second terminal 200 receives the position information from the stylus pen 400, and executes a program or process for processing the received position information. For example, the second terminal 200 performs a position search through an electronic map.

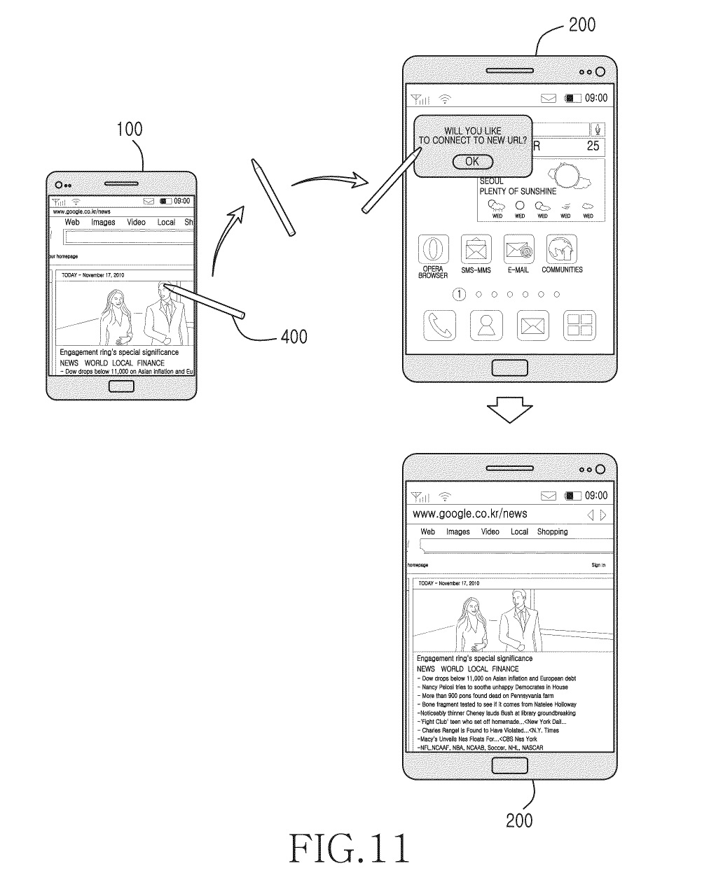

FIG. 11 illustrates a UI screen according to an exemplary embodiment of the present invention.

Referring to FIG. 11, a user touches a webpage on a touchscreen of a first terminal 100 by using a stylus pen 400. The first terminal 100 transmits a URL of the webpage to the stylus pen 400 by using at least one of NFC, Bluetooth and WiFi Direct, and the stylus pen 400 receives and stores the URL from the first terminal 100. When the user touches a touchscreen of a second terminal 200 by using the stylus pen 400, the stylus pen 400 transmits the stored URL received from the first terminal 100, to the second terminal 200 by using at least one of NFC, Bluetooth and WiFi Direct. The second terminal 200 receives the URL from the stylus pen 400, and executes a program or process for processing the received URL. For example, the second terminal 200 connects to the URL through a web viewer.

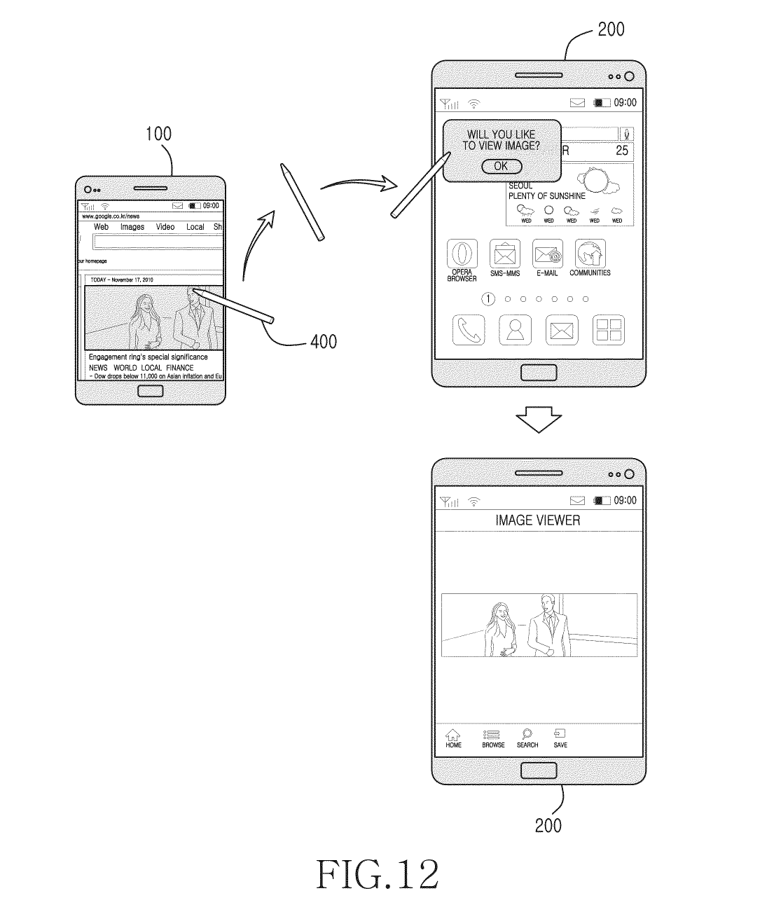

FIG. 12 illustrates a UI screen according to an exemplary embodiment of the present invention.

Referring to FIG. 12, a user touches a multimedia object (e.g., an image or text) in a webpage on a touchscreen of a first terminal 100 by using a stylus pen 400. The first terminal 100 downloads the touched multimedia object from a server, and transmits the downloaded multimedia object to the stylus pen 400 by using at least one of NFC, Bluetooth and WiFi Direct. The stylus pen 400 receives and stores the multimedia object from the first terminal 100. When the user touches a touchscreen of a second terminal 200 by using the stylus pen 400, the stylus pen 400 transmits the stored multimedia object to the second terminal 200 by using at least one of NFC, Bluetooth and WiFi Direct. The second terminal 200 receives the multimedia object from the stylus pen 400, and executes a program or process for processing the received multimedia object. For example, the second terminal 200 opens the multimedia object through a text viewer or an image viewer.

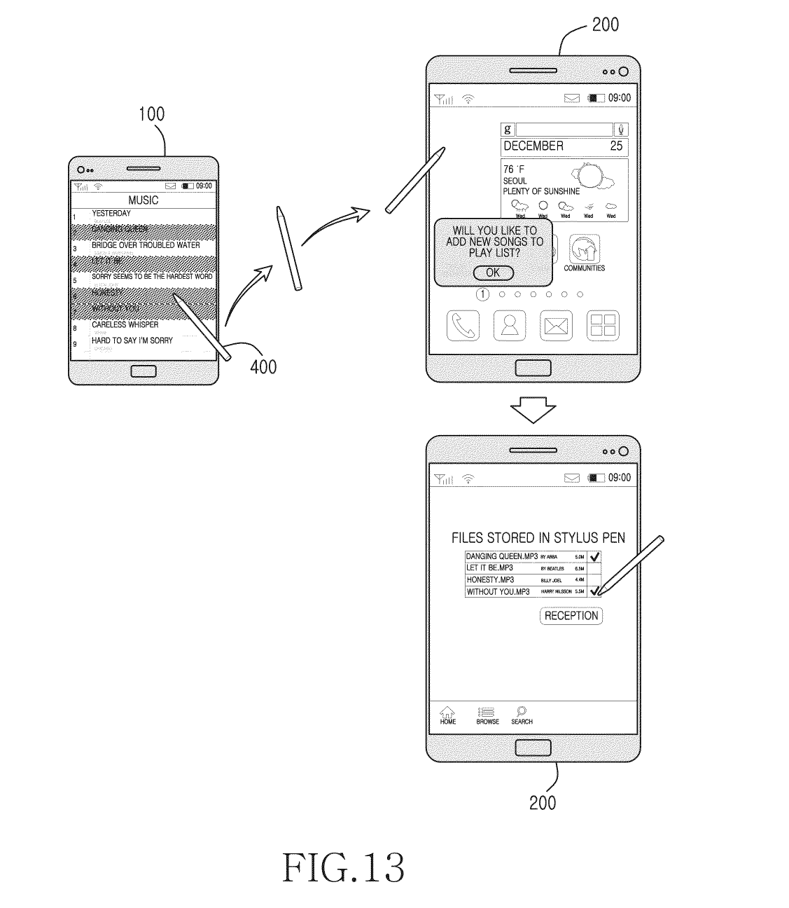

FIG. 13 illustrates a UI screen according to an exemplary embodiment of the present invention.

Referring to FIG. 13, a user touches a plurality of music files in a music list on a touchscreen of a first terminal 100 by using a stylus pen 400. The first terminal 100 transmits the touched music files to the stylus pen 400 by using at least one of NFC, Bluetooth and WiFi Direct, and the stylus pen 400 receives and stores the music files from the first terminal 100. When the user touches a touchscreen of a second terminal 200 by using the stylus pen 400, the stylus pen 400 transmits the stored music files received from the first terminal 100, to the second terminal 200 by using at least one of NFC, Bluetooth and WiFi Direct. As described above, the stylus pen 400 may beforehand transmit metadata of music files to the second terminal 100, and the second terminal 200 may process the metadata and display a list of music files, which may be received from the stylus pen 400, to the user. The user may select a desired music file from the list. The second terminal 200 may request transmission of the music files selected by the user, from the stylus pen 400, and receive the selected music files from the stylus pen 400.

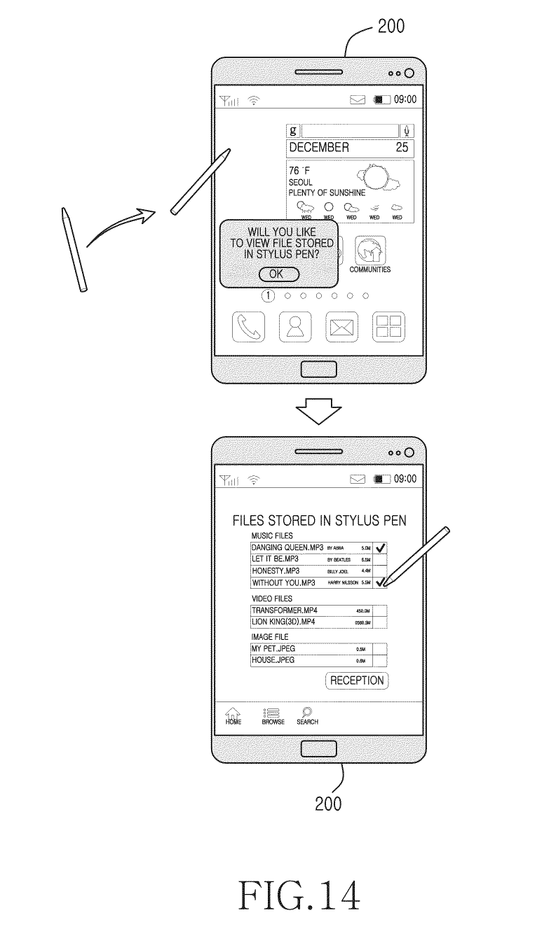

FIG. 14 illustrates a UI screen according to an exemplary embodiment of the present invention.

When a user touches the touchscreen of the second terminal 200 by using the stylus pen 400, the stylus pen 400 transmits metadata of prestored information to the second terminal 200 by using at least one of NFC, Bluetooth and WiFi Direct. The second terminal 200 may process the metadata, generate a list of the information provided by the stylus pen 400, and display the list to the user. The user may select desired information from the list. The second terminal 200 may request transmission of the information selected by the user, from the stylus pen 400, and receive the selected information from the stylus pen 400.

Consequently, by directly or indirectly using the SRC system and the operating method thereof according to the exemplary embodiments of the present invention, the user experience in exchanging information by SRC may be enhanced.

It will be appreciated that embodiments of the present invention according to the claims and description in the specification can be realized in the form of hardware, software or a combination of hardware and software.

Any such software may be stored in a computer readable storage medium. The computer readable storage medium stores one or more programs (software modules), the one or more programs comprising instructions, which when executed by one or more processors in an electronic device, cause the electronic device to perform a method of the present invention.

Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

While the invention has been shown and described with reference to certain exemplary embodiments thereof, it will be understood by those skilled in the art that various changes in form and details may be made therein without departing from the spirit and scope of the invention as defined by the appended claims and their equivalents. Therefore, the scope of the invention is defined not by the detailed description of the invention but by the appended claims, and all differences within the scope will be construed as being included in the present invention.

What is claimed is:

1. A communication system, the system comprising:
a first terminal and a second terminal capable of connecting to each other by one or more Short-range Radio Communication (SRCs),
wherein, when having share information and being connected to the second terminal by the one or more SRCs, the first terminal transmits the share information to the second terminal, and
wherein, when being connected to the first terminal by the one or more SRCs, the second terminal receives the share information from the first terminal.

2. The system of claim 1, wherein the second terminal determines at least one of a program and a process corresponding to the share information received from the first terminal, and processes the received share information through the determined at least one of the program and the process.

3. The system of claim 1, wherein the first terminal transmits metadata of the share information to the second terminal through a first SRC,
wherein, when at least one of the first terminal and the second terminal determines from the metadata that a second communication connection is needed, the first terminal and the second terminal change from the first SRC connection to the second SRC connection or the first terminal and the second terminal additionally connect using the second SRC, and
wherein the first terminal transmits the share information to the second terminal through the second SRC.

4. The system of claim 1, wherein the first terminal transmits metadata of the share information to the second terminal, and
wherein the second terminal provides a list of information to be received from the first terminal based on the metadata, and allows a user to select desired information from the list.

5. The system of claim 1, wherein, when completing transmission of the share information to the second terminal, the first terminal one of releases a share setting of the share information and deletes the share information.

6. The system of claim 1, wherein the first terminal and the second terminal connect using at least one of Near-Field Communication (NFC), Bluetooth communication, and WiFi Direct.

7. The system of claim 1, wherein the share information includes at least one of a contact number, a Uniform Resource Locator (URL), a position, and multimedia.

8. The system of claim 1, wherein at least one of the first terminal and the second terminal includes a touchscreen.

9. The system of claim 1, wherein at least one of the first terminal and the second terminal comprises one of a portable terminal, a mobile phone, a mobile pad, a media player, a tablet computer, a handheld computer, and a Personal Digital Assistant (PDA).

10. The system of claim 1, wherein one of the first terminal and the second terminal comprises a stylus pen for a touchscreen.

11. A stylus pen for a touchscreen in a portable terminal, the stylus pen comprising:
a storage unit for storing a program for controlling operation of the stylus pen, and various data that are at least one of input and output when a control operation is performed; and
a control unit for controlling operation of the stylus pen and at least one of modulating and demodulating of data.

12. The stylus pen of claim 11, further comprising:
an input unit including at least one of a plurality of buttons and a microphone,
wherein the input unit outputs input data corresponding to a button pressed by a user to the control unit, or the input unit outputs voice data corresponding to a user's voice to the control unit.

13. The stylus pen of claim 11, further comprising:
an output unit including at least one of a display and a speaker,
wherein the output unit outputs at least one of voice data and image data demodulated under the control of the control unit.

14. The stylus pen of claim 11, further comprising:
a Short-range Radio Communication (SRC) interface unit for performing one or more SRCs.

15. The stylus pen of claim 11, wherein the stylus pen is used for a Bluetooth call of a mobile phone.

16. A method for operating a communication system including a first terminal and a second terminal capable of connecting to each other by one or more Short-range Radio Communications (SRCs), the method comprising:
transmitting, by the first terminal, share information to the second terminal when the first terminal and the second terminal are connected by the one or more SRCs, and
receiving, by the second terminal, the share information from the first terminal when the first terminal and the second terminal are connected by the one or more SRCs.

17. The method of claim 16, further comprising:
determining, by the second terminal, at least one of a program and a process corresponding to the share information received from the first terminal; and
processing the received share information through the determined at least one of the program and the process.

18. The method of claim 16, wherein the transmitting, by the first terminal, of the share information to the second terminal comprises:
transmitting, by the first terminal, metadata of the share information to the second terminal through a first SRC,
when at least one of the first terminal and the second terminal determines from the metadata that a second SRC connection is needed, changing, by the first terminal and the second terminal, from the first SRC connection to a second SRC or additionally connecting via the second SRC, and
transmitting, by the first terminal, the share information to the second terminal through the second SRC.

19. The method of claim 16, further comprising:
receiving, by the second terminal, metadata of the share information from the first terminal;
providing a list of information to be received from the first terminal based on the received metadata; and
allowing a user to select desired information from the list.

20. The method of claim 16, further comprising:
releasing, by the first terminal, a share setting of the share information or deleting the share information, when completing transmission of the share information to the second terminal.

21. The method of claim 16, wherein the one or more communications include one of Near-Field Communication (NFC), Bluetooth communication and WiFi Direct communication.

22. The method of claim 16, wherein the share information includes at least one of a contact number, a Uniform Resource Locator (URL), a position, and multimedia.

23. The method of claim 16, wherein at least one of the first terminal and the second terminal includes a touchscreen.

24. The method of claim 16, wherein at least one of the first terminal and the second terminal comprises one of a portable terminal, a mobile phone, a mobile pad, a media player, a tablet computer, a handheld computer, and a Personal Digital Assistant (PDA).

25. The method of claim 16, wherein one of the first terminal and the second terminal comprises a stylus pen for a touchscreen.
